(19) United States
(12) Patent Application Publication
(10) Pub. No.: US 2008/0216663 A1
(43) Pub. Date: Sep. 11, 2008

(54) BREWED BEVERAGE MAKER WITH DISPENSING ASSEMBLY

(76) Inventor: Steve Williamson, Arvonia, VA (US)

Correspondence Address: Thomas & Raring, P.C., 536 GRANITE AVENUE, RICHMOND, VA, 23226, US

(21) Appl. No.: 11/684,221

(22) Filed: Mar. 9, 2007

(51) Int. Cl. A47J 31/46; A47J 31/02; A47J 31/50

(52) U.S. Cl. 99/279

(57) ABSTRACT

The invention relates to a dispensing assembly for a coffee maker, such as a high capacity coffee urn, where the dispensing assembly includes an upper and lower body, a valve seat, a valve lever, and a valve seal. Pivoting the valve lever selectively engages the valve seal to lift it up and off the valve seat. In one preferred embodiment, the coffee maker/urn includes an actuatable button that is connected, via a linking mechanism, to the dispensing assembly. The linking mechanism transmits force applied to the actuating button so that the valve lever is engaged. An optional filter may be located adjacent to, and upstream from, the valve seal. The dispensing assembly is assembled as an integrated unit to provide a more robust dispensing apparatus that reduces or eliminates the likelihood of leaking from the valve. The dispensing assembly, therefore, provides pause and serve-type functionality for large capacity urns or standard coffee makers.

### FIELD OF THE INVENTION

The present invention relates to a coffee maker with a cup-actuated dispensing assembly. More specifically, the dispensing assembly of the present invention is intended for use with a large capacity urn but may be used with all types of brewed beverage makers. The assembly is leak resistant or leak proof and is, therefore, suited for a high capacity receptacle.

### BACKGROUND

Urns, such as coffee urns, for dispensing beverages have been known and sold for many years. Fluid dispensing urns may include electrical apparatus to heat, cool, or brew a fluid held in the urn. Typical and traditional dispensing urns include a spout extending at some point from a sidewall of the urn wherein a user actuates a valve associated with the spout to dispense the fluid in the urn.

Coffee urns either hold previously brewed coffee or include a coffee brewing mechanism, such as a percolating mechanism. In a percolating coffee urn fresh water held in the urn moves up through a conduit via siphoning. The lower end of the conduit includes a fluid inlet, and the lower end of the conduit is at least partially held in place in order to support the conduit. The outlet end of the conduit ejects water above a filter basket holding coffee grinds. The heated water is infused by the coffee grinds, and the brewed coffee passes through the filter basket. The urn's fluid reservoir holds the brewed beverage where it is then optionally pulled through the conduit again until a particular strength of coffee is reached. The coffee is dispensed on-demand to a users cup.

Coffee urns are known to include a base that contains a heater or other electrical apparatus. Although rare, some urns include an outlet located in the floor of the urn's fluid reservoir. These types of urns use manually actuated dispensing valves such as a stopcock. A cup-actuated dispensing assembly for a high capacity urn would preferably be more resilient and more leak resistant than known dispensing mechanisms.

With known dispensing valves, a loose fitting filter is placed over the valve seal to screen out wayward coffee grinds. However, customers lose the loose fitting filters or forget to install the filters at all. A more reliable solution is needed.

Known valves operate via a linking mechanism that connects the fluid-receiving receptacle to the operation of the valve. It is possible for the valve seal or the linking arms/levers to break. The broken valve and/or linkage may prevent the valve from properly sealing. Yet, many of the valve seals are directly connected to a linking mechanism component found on the exterior of the coffee maker housing where they can be damaged. Ideally, an improved dispensing mechanism for a coffee maker would eliminate or reduce the possibility of a structural failure leading to unintended dispensing of the brewed beverage.

In general, the use of dispensing mechanism with a high volume receptacle raises new design requirements and considerations. Therefore, there exists a need for an improved dispensing assembly for a coffee urn. Ideally, the dispensing assembly would incorporate valve functionality while reducing or eliminating the possibility of leaks from the dispensing assembly. Of course, an improved dispensing assembly could also used with other brewed beverage makers where the benefits of the improved dispensing assembly would also be appreciated. A dispensing assembly in accordance with the present invention will solve one or more of these or other needs.

### SUMMARY OF THE INVENTION

In accordance with the present invention, a brewed beverage maker with an improved dispensing assembly is provided. In one embodiment, the beverage maker is a coffee maker comprising a large capacity coffee urn. The coffee maker's housing forms a brewed beverage reservoir. The reservoir includes a brewed beverage outlet in the floor of the reservoir.

The dispensing assembly comprises an upper and lower body to be selectively joined together. The upper body is placed above, and projects into, the reservoir outlet. The lower body is located on the exterior of the reservoir and is joined to the upper body by known fastening means, such as by a threaded engagement. The dispensing assembly defines a fluid channel through the reservoir outlet. The assembly is operative to selectively open and close the channel.

The dispensing assembly further includes a pivotable valve lever, a valve seat, and a valve seal. The valve seal is spring biased down into the valve seat. The valve lever selectively displaces the valve seal to open and close the valve provided by the dispensing assembly. The dispensing assembly is thought to be more resilient and foolproof than known dispensing assemblies and is, therefore, more suitable for use with a relatively large capacity coffee urn. The dispensing assembly can also replace APS or cup-actuated APS-style mechanisms in standard brewed beverage makers. In the context of a automatic drip coffee (ADC) maker, “brewed” beverage “reservoir” or “reservoir” is defined and refers to herein as the space below a filter basket and above a brewed beverage outlet “Reservoir” can also apply to carafe-type reservoirs. The dispensing assembly is intended for use with all types of brewed beverage makers.

In one embodiment, the user directly or indirectly actuates the valve lever to open the dispensing assembly valve. In another preferred embodiment, the beverage maker further includes a cup-actuated button and a linking mechanism that transmits force applied to the button to the valve lever. The valve lever translates the motion of the linking mechanism to lift the valve seal off the valve seat.

The dispensing assembly may further include an integrated cap or filter. The cap would be secured above the valve seat. In a preferred embodiment, the cap includes a plurality of apertures sized and shaped to prevent or reduce the possibility of the valve seat becoming contaminated by an object found in the reservoir (e.g., coffee grinds). In still greater detail, the cap/filter and the valve seal are located on a post. A spring sits on the underside of the filter and around the post in order to bias the valve seal down into the valve seat. The integrated filter ensures that a filter is in place when the dispensing assembly is assembled to the coffee maker.

A dispensing assembly in accordance with the present invention efficiently addresses at least one of the shortcomings associated with the prior art. For example, the optional integrated filter eliminates or reduces the possibility of coffee grinds reaching the valve seat. The chance of grinds entering the users coffee mug is also reduced. Also, for the dispensing assembly of the present invention, if any portion of the linking mechanism falls, the valve seal is still properly biased into the valve seat, which reduces the chances for catastrophic failure of the dispensing assembly. In addition, the entire assembly can be detached from the urn for servicing or cleaning. As will be explained below, portions of the assembly can be removed as a module. The construction of the dispensing assembly allows for the dispensing assembly to be cleaned, repaired, refurbished, or the like in whole or in part.

The dispensing assembly provides APS-style functionality for any brewed beverage maker and, in particular, a coffee maker where the coffee maker stores the brewed beverage in a brewed beverage reservoir. Therefore, the dispensing assembly of the present invention addresses at least one of the above and/or additional shortcomings of known brewed beverage dispensing mechanisms.

In another embodiment of the brewed beverage maker described herein, the fluid reservoir includes structural components to be received by or mated to corresponding structural components of a separate base unit. The reservoir is selectively removable from the base. In addition, unlike traditional brewed beverage makers, the urn described herein may interchangeably comprise multiple different reservoirs of varying sizes wherein each reservoir, which provides a range of fluid storage capacities, is operable to mate with the standard base unit. The interchangeable reservoirs include standard structural components to be received by the base. The dispensing mechanism for each reservoir need not be identical. However, each dispensing mechanism for the respective reservoir would cooperate with an actuatable button and linking mechanism on the base (if provided) wherein the button and linking mechanism control the operation of the dispensing mechanism. Therefore users, such as catering companies, can strategically select the reservoir for particular events, functions and parties.

Further features and advantages of the present invention will become apparent to those of skill in the art from the following detailed description of a preferred embodiment taken in conjunction with the accompanying drawings

### BRIEF DESCRIPTION OF THE DRAWINGS

FIG. 1 is a perspective view of a coffee maker in accordance with one embodiment of the present invention;

FIG. 2 is an additional perspective view thereof;

FIG. 3 is an exploded view of thereof;

FIG. 4 is a perspective view of one embodiment of the dispensing assembly of the present invention;

FIG. 5 is an exploded view thereof;

FIG. 6 is a cross sectional view thereof;

FIG. 7 is a side view of a valve lever for use with the dispensing assembly of the present invention;

FIG. 8 is top view thereof; and

FIG. 9 is a cross sectional view of the dispensing assembly, an actuatable button, and a linking mechanism in accordance with one embodiment of the present invention.

### DETAILED DESCRIPTION

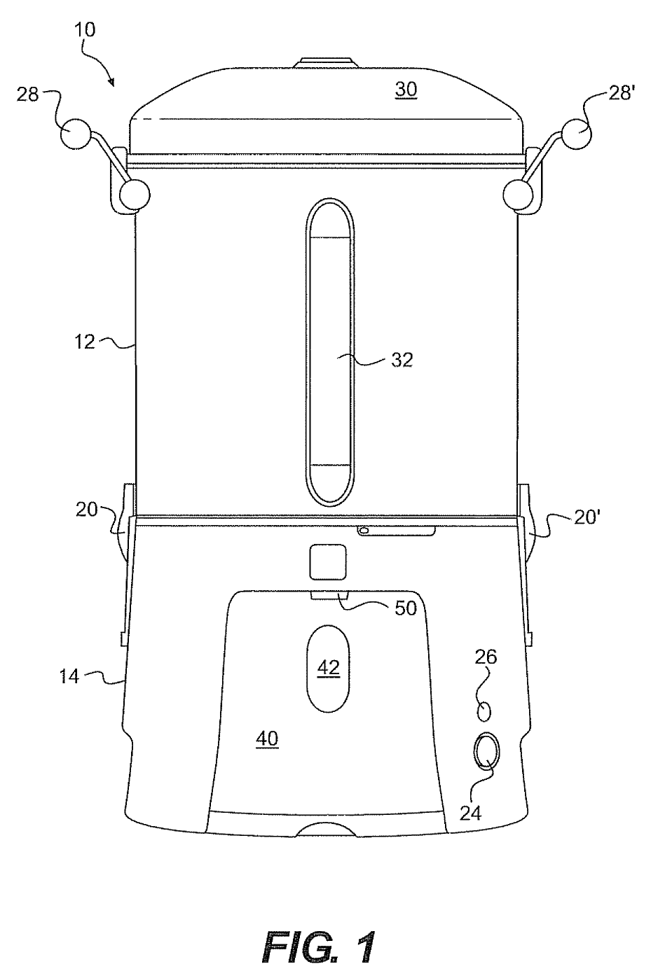

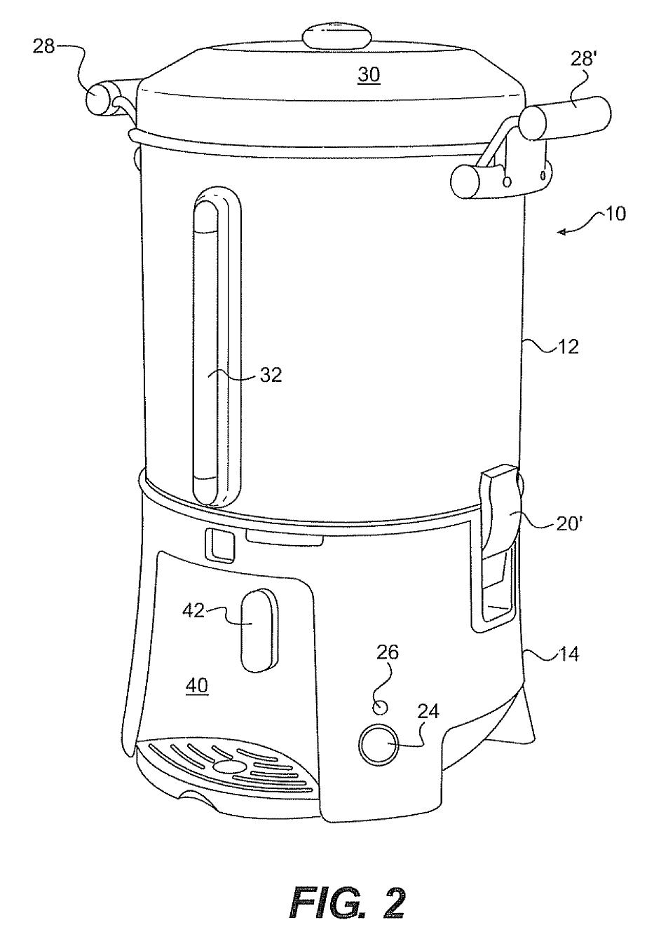

A dispensing assembly for use with a brewed beverage maker in accordance with the present invention provides highly reliable and resilient dispensing valve. With reference to FIGS. 1-3, a coffee maker 10 has a fluid reservoir 12 that sits atop a base 14. The illustrated coffee maker is a percolating-style coffee urn. However, it should be understood that the present invention would be operable with other types of coffee/beverage makers, including drip-type coffee makers, and could be used in place of known APS mechanisms or cup-actuated APS-style mechanisms.

Briefly, and as illustrated, reservoir 12 includes legs 16 that are inserted into base apertures 18. The base and apertures selectively support the reservoir in a specific alignment. A pair of clamps 20, 20′ secure reservoir 12 to base 14 for added stability or in order to transport coffee maker 10.

Base 14 provides an electrical connection 22 that operates to transmit energy to a heating element (not illustrated) in reservoir 12. The element heats the contents of reservoir 12 to initiate percolating-type coffee brewing. Additional electrical components are contained in base 14, including means to connect heating element 22 to an energy source (not illustrated). A power button 24 on the face of base 14 is optionally included to start and/or stop the brewing cycle. An LED 26 can provide information to the operator by indicating to the user whether the brewing cycle is in process, whether element 22 is hot, or the like. The operation of, and incidental electrical components found in, the coffee maker are known in the art and do not need further elaboration here.

Reservoir 14 also includes additional features commonly found with coffee urns. For example, a pair of handles 28, 28′ is provided to lift and transport reservoir 14 or beverage maker 10. A lid 30 selectively covers reservoir 14. A sight glass 32 allows the user to not only determine the volume of fluid in reservoir 14, but also to inspect the strength (indicated by the color) of the brewed beverage. In the context of an automatic drip coffee maker, “reservoir” would be defined as the space below a filter basket and above a reservoir outlet (i.e., the fluid outlet to a carafe or other receptacle). The reservoir for most automatic drip coffee maker would only store the brewed beverage in the event that the dispensing assembly or valve closes the outlet. On the other hand, an urn-type reservoir stores a brewed beverage unless an on-demand valve is opened to permit dispensing of the beverage. The dispensing assembly of the present invention is intended for use with urns, automatic drip beverage makers, and the like.

Unlike standard brewed beverage makers or coffee urns, base 14 of the present invention further includes a recess 40 sized and shaped to allow a cup, mug or other receptacle to be placed within base 14 and under reservoir 12. Within recess 40, an optional, actuatable button 42 is positioned to be engaged by the receptacle placed beneath reservoir 12.

An outlet in the floor of the reservoir is positioned over the recess. The outlet (not illustrated) is an aperture in the reservoir. A dispensing assembly 50, although not illustrated in detail in FIG. 1, is assembled within the outlet. The dispensing assembly provides a fluid channel from reservoir 12 to recess 40. Dispensing assembly 50 selectively permits the dispensing of the brewed beverage held in reservoir 12.

Legs 16 comprise structural components to be received by or mated to corresponding structural components of the separate base unit 14. However, the specific components or structures used to mate the reservoir to the base could comprise other known components. In a preferred embodiment, the outer circumference of reservoir 12 matches the outer circumference of base 14 to create a “one-piece” ornamental design. Variations in design are envisioned.

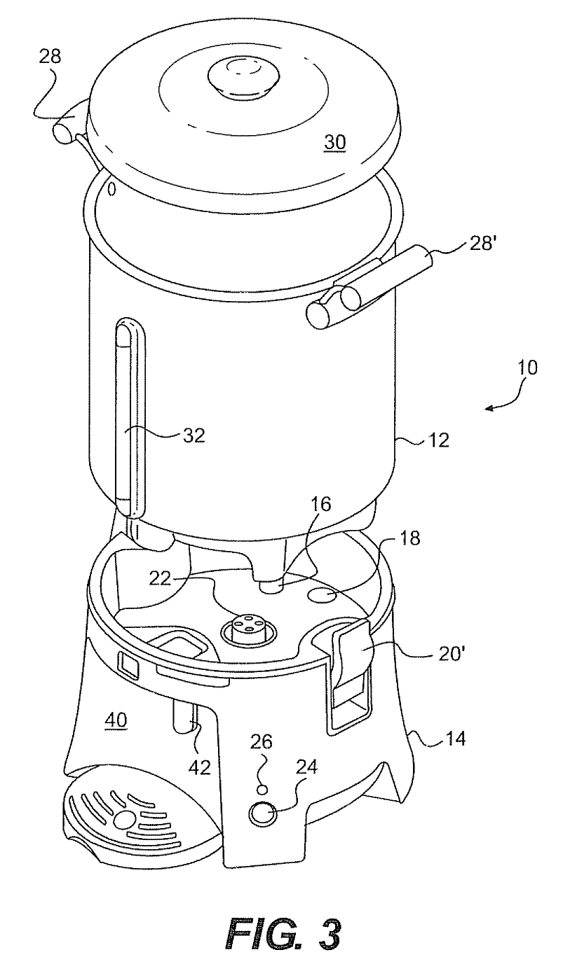

As illustrated in the exploded view of FIG. 3, reservoir 12 is selectively removable from base 14. In addition, unlike traditional brewed beverage makers, urn 10 comprises multiple, interchangeable reservoirs of varying sizes (not illustrated) wherein each reservoir, which together provide a range of different fluid storage capacities, is operable to selectively mate with the standard base unit. In other words, the user has a kit that includes a single, standard base and a plurality of different-sized brewed beverage reservoirs that each have a bottom portion that fits upon the standard base to selectively mate with the standard base.

In further detail, a reservoir with a fluid capacity half as large as the illustrated reservoir, would have a circumference equal to the circumference of the base of the illustrated reservoir 12. Each reservoir within the kit could share an identical circumference, at least at the bottom portion of the reservoir where it mates with the standard base. Alternatively, the base and cross-section of a reservoir may be a shape other than the circular shape illustrated. As such, a reservoir with double the capacity of the illustrated reservoir would still have a bottom circumference equal to reservoir 12. Each interchangeable reservoir includes standard structural components (e.g., legs 16) to be received by base 14 (e.g., received by base apertures 18), or vice-versa. In the context of a brewed beverage urn, the brewed beverage reservoir would further include beverage brewing apparatus, such as coffee percolating apparatus.

The dispensing mechanism for each reservoir need not be identical. However, each dispensing mechanism for the respective reservoir would cooperate with actuatable button 42 and a linking mechanism on the base (if the button and linking mechanism are provided) wherein the button and linking mechanism control the operation of the dispensing mechanism. Therefore users, such as catering companies, can personalize the size of the reservoir for particular events, functions and parties. The capacity of the reservoirs can range from 20 to 150 cups. In a preferred embodiment, one reservoir in the kit has a capacity of 50 cups and another reservoir has a capacity of 100 cups.

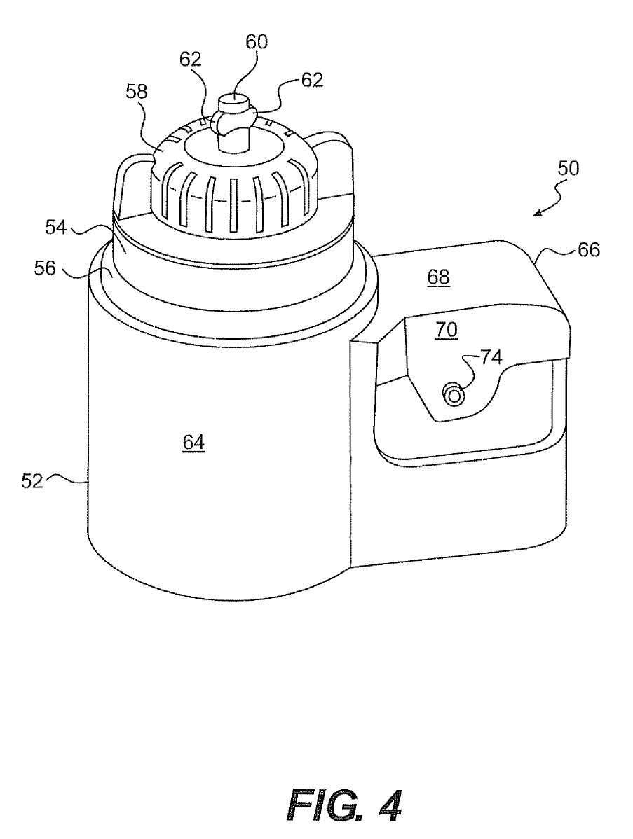

Turning now to FIG. 4, there is illustrated a perspective view of an assembled dispensing assembly 50 in accordance with the present invention. Assembly 50 includes two cylindrical, hollow structural components: lower body 52 and upper body 54. The lower and upper bodies are selectively connected by known fastening means, such as by a threaded engagement. Upper body 54 is positioned above, and projects into, the reservoir outlet. The maximum diameter of the upper body exceeds the diameter of the reservoir outlet. Lower body 52 is positioned on the exterior of reservoir 12. When assembled, the cylindrical and hollow upper and lower bodies 54, 52 define the fluid channel from reservoir 12 to recess 40.

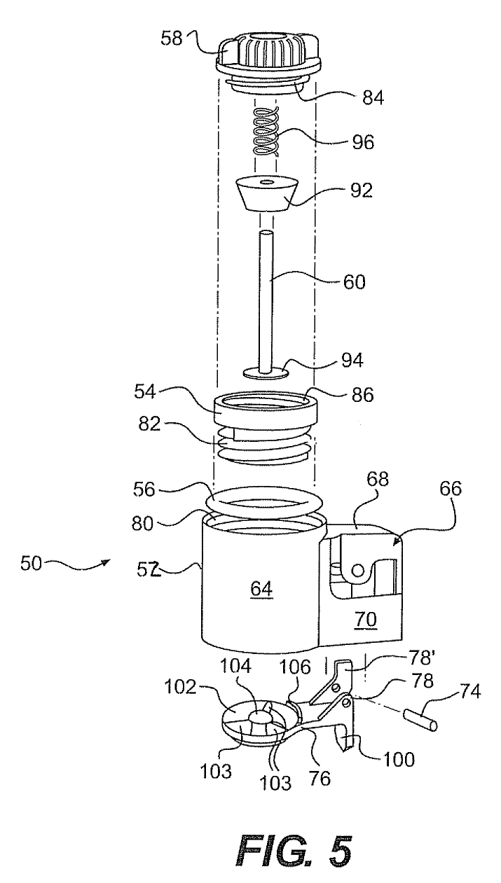

A gasket 56 is placed between lower body 52 and the exterior of reservoir 12. Joining upper body 54 to lower body 52 at least partially compresses gasket 56 in order to prevent fluid from bypassing or seeping out of reservoir 12 and around assembly 50. A portion of upper body 54, as further illustrated by FIGS. 5, 6 and 9, is cylindrical with a diameter less than the diameter of the reservoir outlet. This portion of upper body 54 is selectively secured to lower body 52, A cap 58 is also assembled to upper body 54 opposite lower body 52. Cap 58 is selectively secured by known means, such as by threaded engagement to upper body 54. Cap 58 includes at least one aperture permitting fluid in reservoir 12 to enter upper body 54. In one preferred embodiment, cap 58 includes a plurality of apertures sized and shaped to filter out or inhibit foreign objects in the brewed beverage from entering assembly 50. As illustrated, cap 58 includes spaced slots sized to filter objects, such as coffee grinds, found in reservoir 12. In this preferred embodiment, cap 58 acts as a filter to reduce or eliminate the likelihood that an object may foul or contaminate dispensing assembly 50. In particular, cap 58 reduces the possibility of coffee grinds or other foreign objects from contaminating a valve seat provided by lower body 52.

A post 60 passes through an aperture in cap 58. A protrusion(s) 62 or clamp is added to the post 60 above cap 58 after assembly to prevent cap 58 from being removed from post 60. Therefore, post 60 could include a channel in which a C-shaped clamp would be secured. The clamp is larger in diameter than the aperture in the cap through which the post was inserted. In another preferred embodiment, post 60 is inserted through cap 58 and is then forcefully crimped at the portion of the post exposed above the cap. The post is deformed by the crimping procedure thereby causing protrusions 62.

Lower body 52 comprises a cylindrical housing 64 into which upper body 54 is inserted. The exterior of cylindrical housing 64 includes a hinge appendage 66. Appendage 66 provides a roughly rectilinear structure with a top 68 and two spaced apart and parallel sidewalls 70, 72. The sidewalls include corresponding apertures through which a pin 74 may be inserted.

With specific reference now to the exploded view of FIG. 5, it is further illustrated that cylindrical housing 64 includes female threads 80 to be engaged by male threads 82 provided by upper body 54. Cap 58 includes male cap threads 84 to engage upper female threads 86 provided by upper body 54. Different or additional fastening means for selectively connecting the upper and lower bodies, or the upper body and the cap, would be suitable. However, suitable fasteners should provide a fluid tight connection between the two corresponding components.

A valve lever 76 includes first and second hinge arms 78, 78′. Each arm 78, 78′ includes an aperture that aligns with the sidewall apertures of hinge appendage 66. A first end of lever 76 is dimensioned to fit within appendage 66. Pin 74 passes through the apertures in sidewalls 70, 72 and hinge arms 78, 78′. This creates a pivot point about which lever 76 rotates. Pin 74 therefore creates an axis of rotation, and the first end of the lever is proximate to the axis of rotation.

Post 60 is positioned within the channel defined by the upper and lower bodies 54, 52. A valve seal 92 and spring 96 are also positioned about post 60. Spring 96 is located on the post between cap 58 and valve seal 92. A post stop 94 prevents valve seal 92 from sliding off the lower end of post 60. Prior to assembly, post 60 does not include protrusions 62 or a clamp. These are added after the relative components are assembled on post 60. After assembly, unscrewing cap 58, provides for the removal of cap 58, post 60, valve seal 92, and spring 96 as a modular unit. The construction and operation of assembly 50 will be better understood when considered in cross section and as described below.

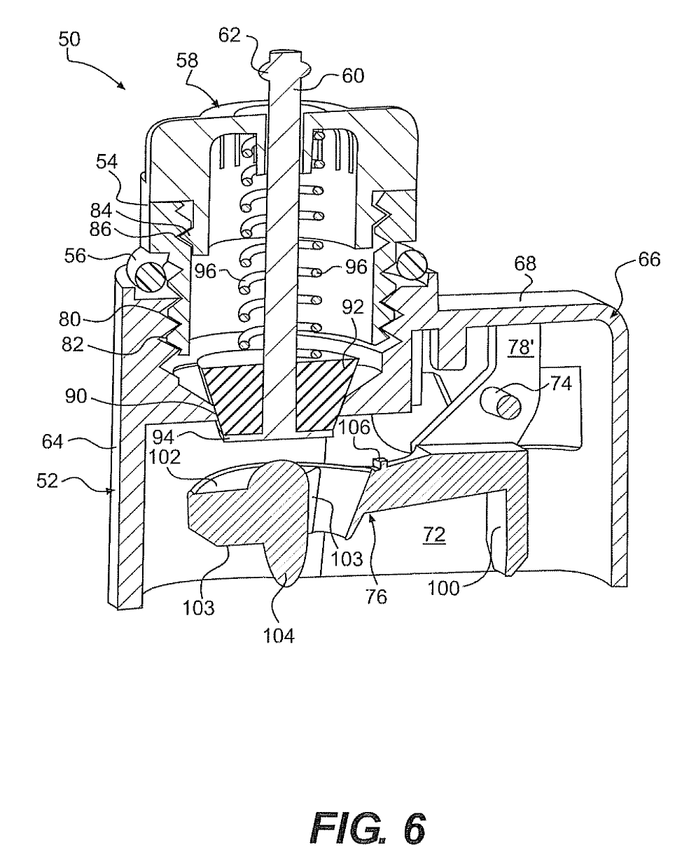

In accordance with dispensing assembly described herein, dispensing assembly 50 provides selective dispensing of a fluid in fluid reservoir 12 via an outlet located in the bottom of the reservoir. Taken in cross section, and as illustrated in FIG. 6, dispensing assembly 10 includes a valve seat 90 provided in lower body 52. Basically, the fluid channel partially defined by lower body 52 is constricted by valve seat 90. Valve seat 90 is an inverted, frustoconical opening located along the channel from reservoir 12 to recess 40.

Valve seal 92 also defines an inverted, frustoconical shape. Valve seal 92 is positioned in assembly 50 above valve seat 90. The valve seal includes a central channel through which post 60 is inserted. The diameter of the central channel and post are substantially the same so that fluid in dispensing assembly 50 cannot flow through the seal channel and, thus, bypass valve seat 90.

The minimum diameter of valve seal 92 is less than the minimum diameter of valve seat 90 so that valve seal 92 can be inserted into valve seat 90. However, valve seal 92 also includes a maximum diameter larger than the narrowest diameter of valve seat 90 so that valve seal 92 cannot pass completely through valve seat 90. Placing valve seal 92 into seat 90 creates a seal that stops the flow of fluid through dispensing assembly 50. Spring 96 creates a downward biasing force on valve seal 92.

The walls of valve seat 90 are more sharply sloped than the outer wall of valve seal 92. The disparity between the two slopes creates less contact surface area between valve seat 90 and valve seal 92. The reduced surface area provides a more reliable and consistent seal. In addition, the slope of the valve seat is thought to increase the flow rate of the fluid past the valve seal when the valve is displaced from the valve seat. The increased pressure/flow rate is more likely to wash foreign objects, such as coffee grinds, off of the valve seat.

Post stop 94 has a diameter wider than the valve seal's central channel but less than the narrowest diameter of valve seat 90. In one preferred embodiment, post stop 94 is a disk located about the end of the post and aligned perpendicular to the axis of the post. The truncated surface of the frustaconical valve seal rests flush against the top surface of post stop 94.

Compression spring 96 is also located about post 60 and is positioned between valve seal 92 and cap 58. As briefly stated above, the dimensions of the spring ensure a constant downward bias on valve seal 92 and post stop 94. The downward bias causes post 60 and post stop 94 to pass through valve seat 90. Valve seal 92 then engages the seat and prevents further downward motion. The valve seal closes or seals the channel created by dispensing assembly 50 and prevents the flow of fluid through the dispensing assembly.

As further illustrated in the cross-sectional view of FIG. 6, valve lever 76 is pivotable about pin 74. Lever 76 is roughly perpendicular to the axis of the dispensing assembly channel. The first end of the lever is positioned within hinge appendage 66. The first end includes a downwardly facing leg 100. The second, or valve-engaging end, includes a cylindrical, funnel wall 102, and, within assembly 50, is positioned proximate to valve post stop 94 and/or valve seal 92. The diameter of the cylindrical wall exceeds the diameter of the reservoir outlet. Wall 102 is “funnel shaped” in that the interior of the wall slopes inward moving from the top of the wall to the bottom of the wall. The wall defines a funnel opening beneath the reservoir outlet. The funnel opening is operable to guide dispensed fluid through the lever to a receptacle beneath the dispensing assembly.

Vanes 103 extend inward from wall 102 towards a center point where there is supported a central member 104. The height of the vertically aligned member (i.e., the member is aligned perpendicularly to the axis of lever 76) exceeds the height of wall 102. The top of member 104 is closer to post stop 94 than the top of wall 102. As the lever is pivoted about pin 74, member 104 contacts post stop 94. Sufficient force on lever 76 overcomes the downward bias of spring 96. As such, lever 76, via member 104, selectively lifts valve seal 92 off of valve seat 90. Member 104 has an ovoid shape to better channel fluid along the vertical axis of the member. In general, the lever acts to selectively open the channel defined by the upper and lower bodies of the dispensing assembly.

At rest, member 104 may remain in contact with post stop 94 there may be some space between the member 104 and stop 94. In a preferred embodiment, the second end of valve lever 76 is lower than the first end of lever 76. Therefore, the lever slopes downwardly away from pin 74 towards post stop 94. In another preferred embodiment, lever 76 is shaped or molded to provide a downward slope away from pin 74. In any event, a downward slope is preferably provided so that fluid on top of lever 76 drains towards cylindrical wall 102.

At least one of the lever hinge arms 78, 78′ is extended or dimensioned so as to contact top 68 of appendage 66. Specifically, the downward rotation of member 104 is limited because the extended hinge arm(s) acts as a stop.

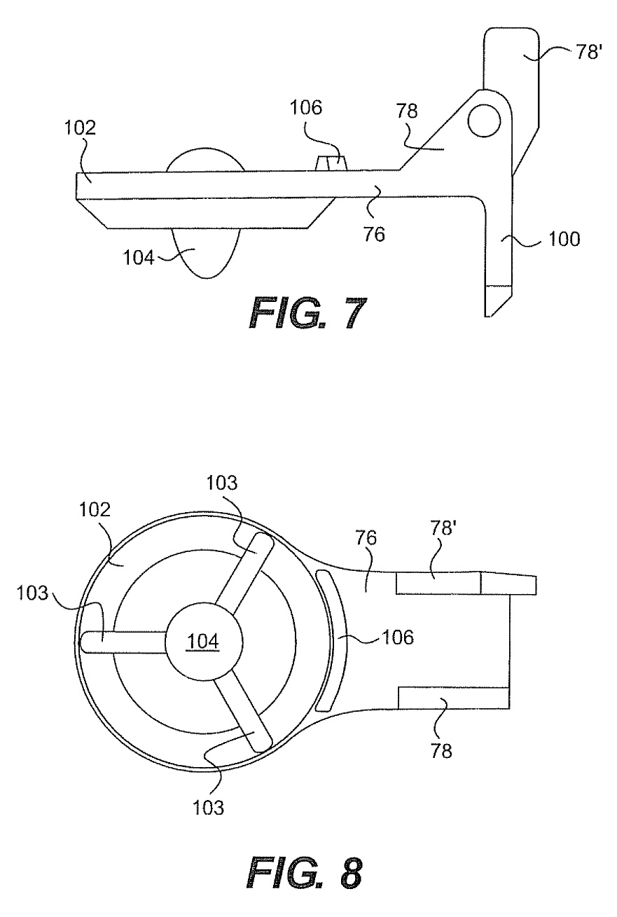

Lever 76 is further illustrated in FIGS. 7 and 8. Viewed from the side, it is apparent that wall 102 is tapered towards member 104. The tapered shape is thought to reduce or eliminate splashing and/or to further channel the fluid being dispensed from assembly 50 to a receptacle. Lever 76 further includes a dividing wall or divider 106 between wall 102 and the first end of valve lever 76. Dividing wall 106 is arranged perpendicular to the axis of lever 76. Divider 106 is provided to limit, reduce, or eliminate the possibility of the dispensed fluid contaminating the upper portion of lever 76. Therefore, lever 76 is more sanitary and/or clean relative to the lever without the divider.

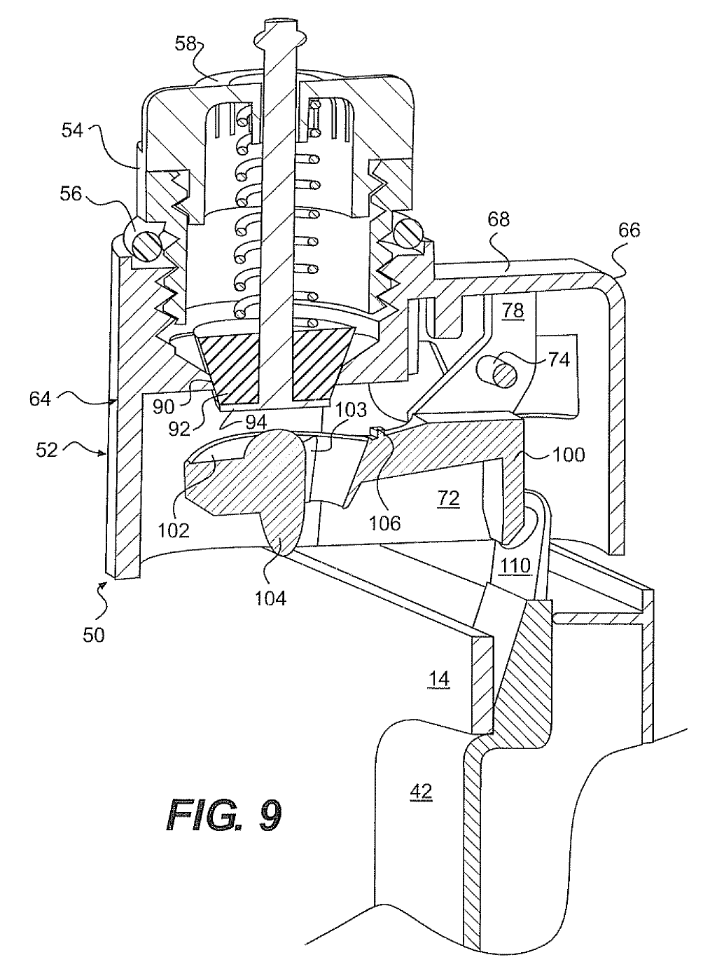

Lever 76 can be pivoted directly or indirectly in order to selectively dispense the fluid. As illustrated in FIG. 9, a cup-actuated button 42 can be included on the brewed beverage maker. By depressing button 42 towards base housing 14, force is translated into a forward motion by a linking arm 110. Arm 110 rotates lever leg 100 toward member 104. Therefore, lever 76 rotates about pin 74, member 104 contacts post stop 94, and valve seal 92 is lifted off of valve seat 90. In the event lever 76 were to break or otherwise fail, spring 96 biases the seal onto the seat to provide a fail-safe mechanism.

In use, fluid enters the dispensing assembling through the aperture or apertures in cap 58, flows around valve seal 92, through the valve seat opening and into the cup, mug, or other receptacle used to actuate button 42. Through this linking mechanism, dispensing assembly 50 provides dispensing of a brewed beverage from a brewed beverage reservoir. However, in the event that linking arm 10, or any part of lever 76 were to fail, valve seal 92 remains biased against valve seat 90.

The user may also selectively dismantle assembly 50 by disconnecting the upper and lower bodies. In addition, the cap, post, spring, and valve seal can be disconnected as a unit from the upper body. Therefore, assembly 50 can be disassembled from beverage maker 10 in order to clean, refurbish or replace the assembly, in whole or in part, as needed.

Overall, the unique dispensing assembly for a brewed beverage maker of the present invention prevents or reduces the possibility of leaking from the dispensing valve. The possibility of a dispensing valve failure is also reduced relative to other dispensing assemblies. Moreover, the integrated cap/filter reduces foreign objects that might be found in a brewed beverage reservoir, such as coffee grinds, from entering the dispensing assembly and possibly contaminating the assembly or preventing a seal between the valve seal and valve seat. The optional linking mechanism dependably translates the movement of a cup-actuated button to selectively open the dispensing assembly.

While the invention has been described with reference to specific embodiments thereof, it will be understood that numerous variations, modifications and additional embodiments are possible, and all such variations, modifications, and embodiments are to be regarded as being within the spirit and scope of the invention. For instance, the specific shape of the valve seal, lever, cap, or the like could be altered without deviating from the invention as claimed below.

What is claimed is:

1. A brewed beverage maker and dispensing assembly comprising:
a brewed beverage maker including a brewed beverage reservoir, the reservoir including a brewed beverage outlet; and
the dispensing assembly comprising
an upper body and a lower body, the upper body located at least partially within the brewed beverage reservoir and protecting through the outlet, the lower body located on the exterior of the fluid reservoir and providing a valve seat, the upper and lower bodies selectively joined to each other wherein the upper and lower bodies define a channel through the brewed beverage outlet;
a valve lever pivotally mounted to the lower body;
a valve seal positioned above said valve seat,
a compression spring, the spring operable to bias the valve seal to engage the valve seat;
wherein pivoting the valve lever selectively lifts the valve seal off of the valve seat in order to open the channel defined by the dispensing assembly.

2. The brewed beverage maker and dispensing assembly of claim 1, further comprising a cap selectively connected to the upper body opposite the lower body, the cap including at least one aperture for fluid in the reservoir to enter the dispensing assembly.

3. The brewed beverage maker and dispensing assembly of claim 2, wherein the cap includes a plurality of apertures, the apertures sized and dimensioned to inhibit foreign objects in the fluid from entering the dispensing assembly.

4. The brewed beverage maker and dispensing assembly of claim 2, further comprising a post extending through said cap, upper body, and valve seat, the valve seal and spring located around the post.

5. The brewed beverage maker and dispensing assembly of claim 4, the post further comprising a post stop at a first end and at least one protrusion at a second end, the post stop and the at least one protrusion preventing the removal of the cap, the valve seal, or the spring from the post, wherein selectively disconnecting the cap from the upper body permits the removal of the cap, the post, the valve seal, and the spring from the dispensing assembly as a modular unit.

6. The brewed beverage maker and dispensing assembly of claim 1, the beverage maker further comprising an actuatable button and a linking mechanism wherein actuating the button transmits a pivoting force to the valve lever via the linking mechanism.

7. The brewed beverage maker and dispensing assembly of claim 1, the valve lever further comprising a first end and a second end, the second end proximate to the valve seal, the second end further comprising a cylindrical wall defining a funnel opening through the lever and a member supported within the funnel opening.

8. The brewed beverage maker and dispensing assembly of claim 7, the valve lever further comprising a first hinge arm and a second hinge arm, each arm providing an aperture aligned with an aperture on the corresponding hinge arm, and wherein a pin is selectively inserted through the lower body and aligned hinge arm apertures to provide an axis of rotation, the valve lever pivoting about said axis.

9. The brewed beverage maker and dispensing assembly of claim 7, the valve lever further comprising a dividing wall substantially perpendicular to the axis of the lever, the dividing wall located between the cylindrical wall and the first end of the lever.

10. The brewed beverage maker and dispensing assembly of claim 1, the beverage maker further comprising a receptacle recess beneath the beverage reservoir.

11. A brewed beverage maker and dispensing assembly comprising:
a brewed beverage maker including a brewed beverage reservoir, the reservoir including a brewed beverage outlet; and
the dispensing assembly comprising
an upper body and a lower body, the upper body located at least partially within the brewed beverage reservoir and projecting through the outlet, the lower body located on the exterior of the brewed beverage reservoir and providing a valve seat, the upper and lower bodies selectively joined to each other wherein the upper and lower bodies defines a channel through the brewed beverage outlet;
a valve lever pivotally mounted to the lower body,
a cap selectively mounted to the upper body opposite the lower body, the cap including a plurality of apertures for fluid in the reservoir to enter the dispensing assembly, the apertures sized and shaped to inhibit foreign objects in the fluid from entering the dispensing assembly;
a post extending through said cap, upper body, and valve seat;
a valve seal positioned around the post;
a spring positioned around the post between the valve seal and cap, the spring biasing the valve seal into the valve seat;
wherein pivoting the valve lever selectively lifts the valve seal off of the valve seat in order to open the channel defined by the dispensing assembly.

12. The brewed beverage maker and dispensing assembly of claim 10, the post further comprising a post stop at a first end and at least one protrusion at a second end, the post stop and the at least one protrusion preventing the removal of the cap, the valve seal, or the spring from the post, wherein selectively disconnecting the cap from the upper body permits the removal of the cap, the post, the valve seal, and the spring from the dispensing assembly as a modular unit.

13. The brewed beverage maker and dispensing assembly of claim 10, the beverage maker further comprising an actuatable button and a linking mechanism wherein actuating the button transmits a pivoting force to the valve lever via the linking mechanism.

14. The brewed beverage maker and dispensing assembly of claim 10, the valve lever further comprising a first end and a second end, the second end proximate to the valve seal, the second end further comprising a cylindrical wall defining a funnel opening through the lever and a member supported within the funnel opening.

15. The brewed beverage maker and dispensing assembly of claim 13, the valve lever further comprising a first hinge arm and a second hinge arm, each arm providing an aperture aligned with an aperture on the corresponding hinge arm, and wherein a pin is selectively inserted through the lower body and aligned hinge arm apertures to provide an axis of rotation, the valve lever pivoting about said axis.

16. The brewed beverage maker and dispensing assembly of claim 13, the valve lever further comprising a dividing wall substantially perpendicular to the axis of the lever, the dividing wall located between the cylindrical wall and the first end of the lever.

17. A brewed beverage maker kit comprising:
a base;
a plurality of interchangeable fluid reservoirs, each reservoir operable to store a fluid, to be selectively received by and secured on the base, and including a beverage brewing apparatus, each reservoir having substantially the same shape as every other reservoir at a bottom portion of each reservoir; and wherein the plurality of reservoirs provide a range of different fluid storage capacities.

18. The brewed beverage making kit of claim 17, the base further comprising an actuatable button and linking mechanism and each reservoir further comprising a dispensing assembly, the dispensing assembly operable to selectively dispense a fluid from the respective reservoir; wherein actuating the button transmits a force to operate the dispensing assembly, the force transmitted from the button to the dispensing assembly via the linking mechanism.

19. The brewed beverage kit of claim 17, wherein one reservoir of said plurality of reservoirs provides a 50 cup capacity.

19. The brewed beverage kit of claim 17, wherein one reservoir of said plurality of reservoirs provides a 100 cup capacity
